(19) United States
(12) Patent Application Publication
(10) Pub. No.: US 2026/0342523 A1
(43) Pub. Date: Oct. 29, 2026

(54) TRANSMISSION CONFIGURATION INDICATOR (TCI) FRAMEWORK FOR MULTIPLE TRANSMISSION AND RECEPTION POINTS (mTRPs)

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Jing SUN, San Diego, CA (US); Tao LUO, San Diego, CA (US)

(21) Appl. No.: 19/099,009

(22) PCT Filed: Sep. 30, 2022
(86) PCT No.: PCT/CN2022/123229

§ 371 Date: Jan. 27, 2025

(51) Int. Cl. H04L 5/00; H04W 72/0453

(52) U.S. Cl. CPC H04L 5/0094; H04W 72/0453

(57) ABSTRACT

A method of wireless communication by a user equipment communicating with a multiple transmission and reception point (mTRP) system includes receiving a first indication for a first unified transmission configuration indicator (TCI) and a second unified TCI during a first time period. Each of the TCIs corresponds to a portion of a transmission. The method also includes receiving a second indication for a third unified TCI during a second time period, after the first time period. The method further includes determining whether to apply to the transmission, the third unified TCI, the first unified TCI or the second unified TCI. The transmission may be a frequency domain resource allocation (FDRA) or a set of repetitions.

### FIELD OF THE DISCLOSURE

The present disclosure relates generally to wireless communications, and more specifically to a transmission configuration indicator (TCI) framework for multiple transmission and reception points (mTRPs).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IOT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promul gated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

Aspects of the present disclosure are directed to a method of wireless communication by a user equipment (UE) communicating with a multiple transmission and reception point (mTRP) system. The method includes receiving a first indication for a first unified transmission configuration indicator (TCI) and a second unified TCI during a first time period. Each of the TCIs corresponds to a portion of a transmission. The method also includes receiving a second indication for a third unified TCI during a second time period, after the first time period. The method further includes determining whether to apply to the transmission, the third unified TCI, the first unified TCI or the second unified TCI.

In other aspects of the present disclosure, a method of wireless communication by a network device in a multiple transmission and reception point (mTRP) system includes transmitting a first indication for a first unified transmission configuration indicator (TCI) and a second unified TCI during a first time period. Each of the TCIs corresponds to a portion of a transmission. The method also includes transmitting a second indication for a third unified TCI during a second time period, after the first time period. The method further includes communicating in accordance with the third unified TCI, the first unified TCI or the second unified TCI.

Other aspects of the present disclosure are directed to an apparatus for a user equipment (UE) communicating with a multiple transmission and reception point (mTRP) system. The apparatus has a memory and one or more processors coupled to the memory. The processor(s) is configured to receive a first indication for a first unified transmission configuration indicator (TCI) and a second unified TCI during a first time period. Each of the TCIs corresponds to a portion of a transmission. The processor(s) is also configured to receive a second indication for a third unified TCI during a second time period, after the first time period. The processor(s) is further configured to determine whether to apply to the transmission, the third unified TCI, the first unified TCI or the second unified TCI.

Other aspect of the present disclosure are directed to an apparatus for a network device in a multiple transmission and reception point (mTRP) system. The apparatus has a memory and one or more processors coupled to the memory. The processor(s) is configured to transmit a first indication for a first unified transmission configuration indicator (TCI) and a second unified TCI during a first time period. Each of the TCIs corresponds to a portion of a transmission. The processor(s) is also configured to transmit a second indication for a third unified TCI during a second time period, after the first time period. The processor(s) is further configured to communicate in accordance with the third unified TCI, the first unified TCI or the second unified TCI.

In other aspects of the present disclosure, a non-transitory computer-readable medium with non-transitory program code recorded thereon is disclosed for a user equipment (UE) communicating with a multiple transmission and reception point (mTRP) system. The program code is executed by a processor and includes program code to receive a first indication for a first unified transmission configuration indicator (TCI) and a second unified TCI during a first time period. Each of the TCIs corresponds to a portion of a transmission. The program code also includes program code to receive a second indication for a third unified TCI during a second time period, after the first time period. The program code further includes program code to determine whether to apply to the transmission, the third unified TCI, the first unified TCI or the second unified TCI.

Other aspects of the present disclosure are directed to an apparatus for a user equipment (UE) communicating with a multiple transmission and reception point (mTRP) system. The apparatus includes means for receiving a first indication for a first unified transmission configuration indicator (TCI) and a second unified TCI during a first time period. Each of the TCIs corresponds to a portion of a transmission. The apparatus also includes means for receiving a second indication for a third unified TCI during a second time period, after the first time period. The apparatus further includes means for determining whether to apply to the transmission, the third unified TCI, the first unified TCI or the second unified TCI.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4A is a block diagram illustrating an example operation of a multiple transmission and reception point (mTRP) system, in accordance with aspects of the present disclosure.

FIG. 4B is a block diagram illustrating an example of different transmission schemes for a multiple transmission and reception point (mTRP) system, in accordance with aspects of the present disclosure.

FIG. 5 is a block diagram illustrating an example of frequency division multiplexed (FDM) semi persistently scheduled (SPS) physical downlink shared channel (PDSCH) transmissions, in accordance with aspects of the present disclosure.

FIG. 6 is a block diagram illustrating an example of frequency division multiplexed (FDM) semi persistently scheduled (SPS) physical downlink shared channel (PDSCH) transmissions for two redundancy versions, in accordance with aspects of the present disclosure.

FIG. 7 is a block diagram illustrating an example of intra-slot time division multiplexed repetitions, in accordance with aspects of the present disclosure.

FIG. 8 is a block diagram illustrating an example of inter-slot time division multiplexed repetitions, in accordance with aspects of the present disclosure.

FIG. 9 is a flow diagram illustrating an example process performed, for example, by a user equipment (UE), in accordance with various aspects of the present disclosure.

FIG. 10 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Quasi-co-location (QCL) signaling supports multiple beam operations, as well as multiple transmission and reception point device (mTRP) operations. Two signals may be quasi-co-located when a first signal is a source for a second signal. Channel parameters for the second signal may be estimated based on observations of the first signal. The set of shared parameters may differ for different transmission schemes and network architectures. QCL is configured by transmission configuration indicator (TCI) states.

Although a TCI state may apply to either a downlink transmission or an uplink transmission, a base station and a user equipment (UE) may use a unified TCI state framework for both downlink and uplink communications. In the unified TCI state framework, TCI state indications may indicate a joint downlink and uplink TCI state or indicate separate downlink and uplink TCI states. Such a TCI state indication that may be used to indicate a joint downlink and uplink beam, a separate downlink beam, or a separate uplink beam is referred to as a unified TCI state indication. In some examples, the unified TCI state indication may be “sticky,” such that the indicated beam direction will be used for the channels and/or reference signals to which the TCI state indication applies until a further indication is received.

Aspects of the present disclosure relate to a unified TCI framework for indicating multiple downlink (DL) and uplink (UL) transmission configuration indicator (TCI) states for a multiple transmission and reception point (mTRP) system. Some aspects of the present disclosure apply when two sticky unified TCIs are originally indicated, but later, only one sticky TCI is indicated. In these aspects, one TCI is assigned for each half of a frequency domain resource assignment (FDRA) where a single redundancy version (RV) is indicated. According to aspects of the present disclosure, when multiple TCIs are first indicated, but only a single TCI is later indicated, all FDRA parts use the later indicated TCI for the single RV physical downlink shared channel (PDSCH).

In case two redundancy versions are present, one TCI may apply to each repetition (e.g., each RV). According to some optional aspects of the present disclosure, when multiple TCIs are first indicated, but only a single TCI is later indicated, all repetitions use the later TCI. In alternative aspects, only the first repetition is kept. The first repetition uses the later indicated TCI, or one of the originally mapped first or second TCIs.

Aspects of the present disclosure also address time division multiplexing (TDM) scenarios. In case multiple repetitions are transmitted within a single slot (e.g., intra-slot), both repetitions may use a later signaled TCI. Aspects of the present disclosure address how to handle a configured gap between the two repetitions. In a first option, the gap is kept between the repetitions. In a second option, the gap is reset to zero, or is ignored between the repetitions. In a third option, only the first repetition is kept, with either the later indicated TCI, or the TCI originally mapped to the first repetition. In case multiple repetitions are transmitted in different slots (e.g., inter-slot), both repetitions may use a later signaled TCI. In another option, only the first repetition is kept, using either the later indicated TCI, or the TCI originally mapped to the first repetition.

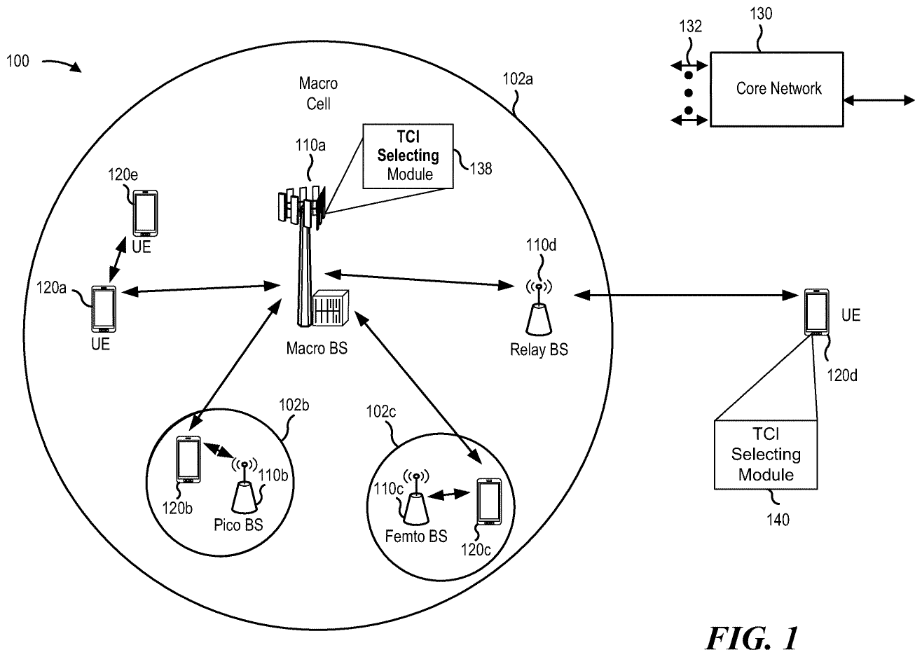

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a TCI selecting module 140. For brevity, only one UE 120d is shown as including the TCI selecting module 140. The TCI selecting module 140 may receive a first indication for a first unified transmission configuration indicator (TCI) and a second unified TCI during a first time period. Each of the TCIs corresponds to a portion of a transmission. The TCI selecting module 140 may also receive a second indication for a third unified TCI during a second time period, after the first time period. The TCI selecting module 140 may further determine whether to apply to the transmission, the third unified TCI, the first unified TCI or the second unified TCI.

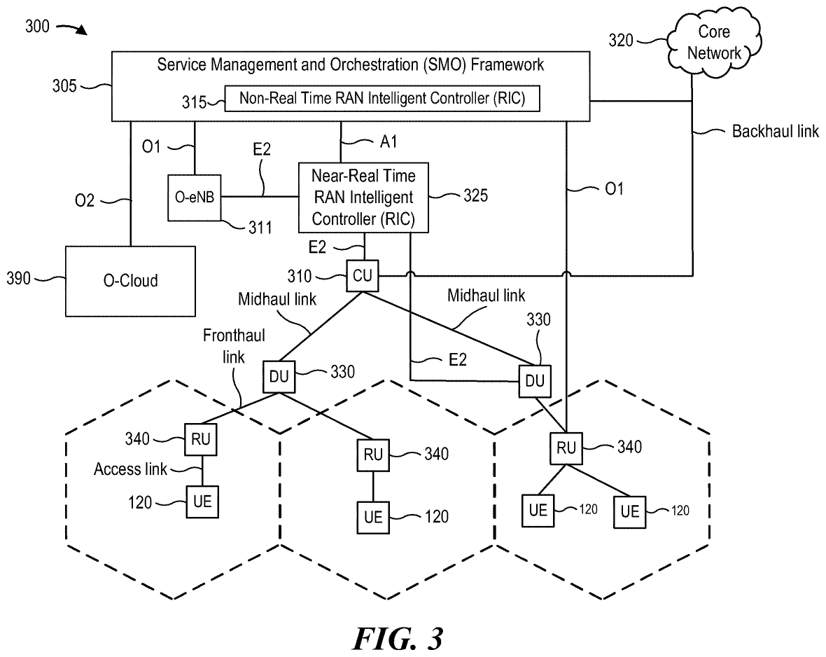

The core network 130 or the base stations 110 or any other network device (e.g., as seen in FIG. 3) may include a TCI selecting module 138. For brevity, only one base station 110a is shown as including the TCI selecting module 138. The TCI selecting module 138 may transmit a first indication for a first unified transmission configuration indicator (TCI) and a second unified TCI during a first time period. Each of the TCIs corresponds to a portion of a transmission. The TCI selecting module 138 may also transmit a second indication for a third unified TCI during a second time period, after the first time period. The TCI selecting module 138 may further communicate with the third unified TCI, the first unified TCI or the second unified TCI.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IOT) devices, and/or may be implemented as NB-IOT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

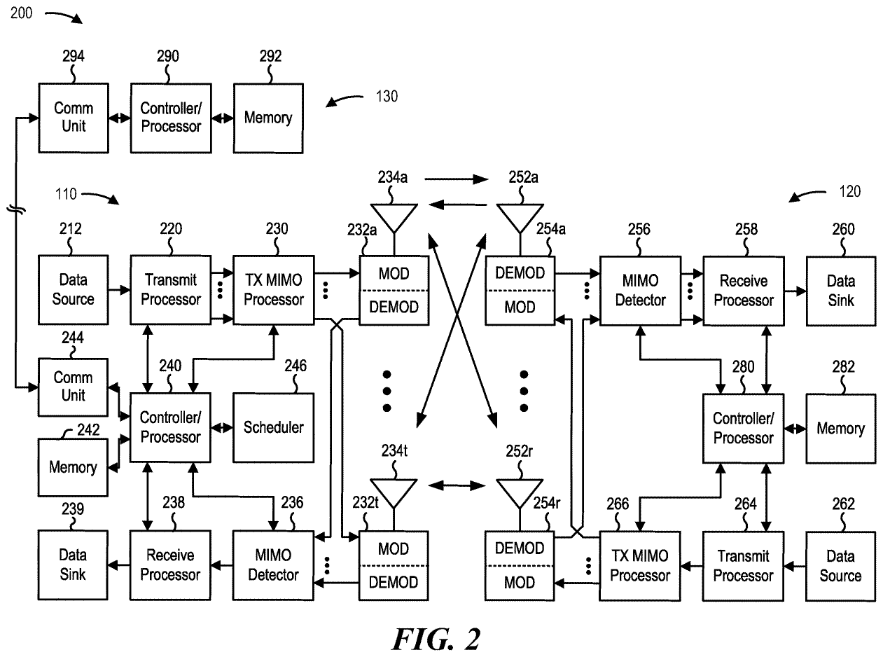

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

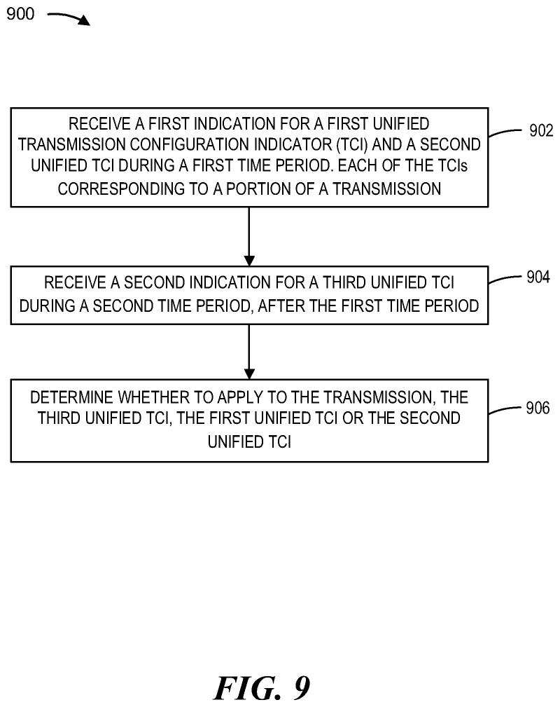

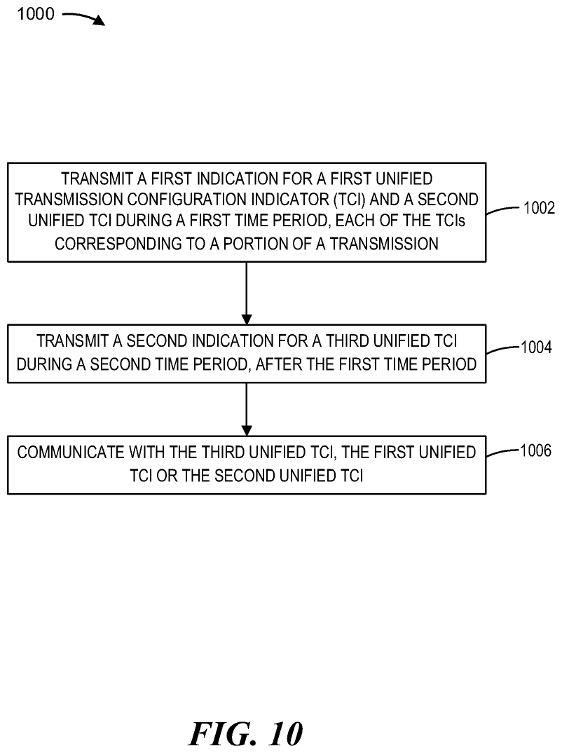

The controller/processor 240 of the base station 110, the controller/processor 280 of the UE 120, and/or any other component(s) of FIG. 2 may perform one or more techniques associated with TCI selection as described in more detail elsewhere. For example, the controller/processor 240 of the base station 110, the controller/processor 280 of the UE 120, and/or any other component(s) of FIG. 2 may perform or direct operations of, for example, the processes 900 and 1000 of FIGS. 9 and 10 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for determining, means for transmitting, and means for communicating. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an Ol interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an Ol interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as Al policies).

Quasi-co-location (QCL) signaling supports multiple beam operations, as well as multiple transmission and reception point (mTRP) operations. Two signals may be quasi-co-located when a first signal is a source for a second signal. Channel parameters for the second signal may be estimated based on observations of the first signal. The set of shared parameters may differ for different transmission schemes and network architectures. QCL is configured by transmission configuration indicator (TCI) states.

Although a TCI state may apply to either a downlink transmission or an uplink transmission, a base station and a UE may use a unified TCI state framework for both downlink and uplink communications. In the unified TCI state framework, TCI state indications may indicate a joint downlink and uplink TCI state or indicate separate downlink and uplink TCI states. Such a TCI state indication that may be used to indicate a joint downlink and uplink beam, a separate downlink beam or a separate uplink beam is referred to as a unified TCI state indication. A unified TCI state indication (e.g., a joint downlink and uplink TCI state indication and/or separate downlink and uplink TCI state indications) may be applied to multiple channels. For example, the unified TCI state indication of a joint uplink and downlink TCI state may indicate a beam direction for one or more downlink channels (e.g., physical downlink shared channel (PDSCH) and/or physical downlink control channel (PDCCH)) or reference signals (e.g., channel state information reference signal (CSI-RS)) and for one or more uplink channels (e.g., a physical uplink shared channel (PUSCH) and/or a physical uplink control channel (PUCCH)) or reference signals (e.g., a sounding reference signal (SRS)). The unified TCI state indication of a separate downlink TCI state may indicate a beam direction for multiple downlink channels (e.g., PDSCH and PDCCH) or reference signals (e.g., CSI-RS). The unified TCI state indication of a separate uplink TCI state may indicate a beam direction for multiple uplink channels (e.g., PUSCH and PUCCH) or reference signals (e.g., SRS). In some examples, the unified TCI state indication may be “sticky,” such that the indicated beam direction will be used for the channels and/or reference signals to which the TCI state indication applies until a further indication is received.

Aspects of the present disclosure relate to a unified TCI framework for indicating multiple downlink (DL) and uplink (UL) transmission configuration indicator (TCI) states for a multiple transmission and reception point (mTRP).

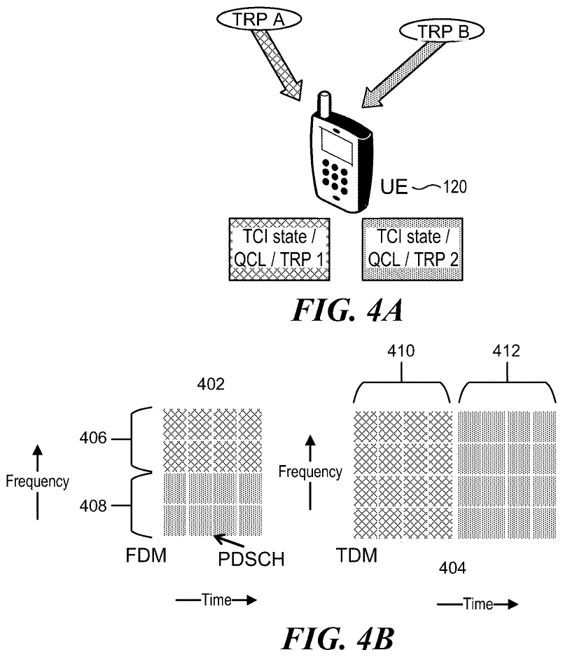

FIG. 4A is a block diagram illustrating an example of mTRP device operations, in accordance with aspects of the present disclosure. In the example of FIG. 4A, a first TRP, TRP A, and a second TRP, TRP B, communicate with a UE 120. The first TRP, TRP A, communicates in accordance with a first TCI state and quasi-co-location configuration. The second TRP, TRP B, communicates in accordance with a second TCI state and quasi-co-location configuration. Thus, it can be seen that different TRPs (TRP a, TRP B) can communicate with a UE 120 using different TCI states.

FIG. 4B is a block diagram illustrating an example of different transmission schemes for an m TRP system, in accordance with aspects of the present disclosure. Different TCI states (e.g., the first and second TCI states shown in FIG. 4A) may be frequency division multiplexed (FDM) or time division multiplexed (TDM). For example, as seen in a first diagram 402, a physical downlink shared channel (PDSCH) may be transmitted with a first TCI in a first portion 406 of the frequency domain resource allocation (FDRA) and transmitted with a second TCI in a second portion 408 of the FDRA. As seen in a second diagram 404, a physical downlink shared channel (PDSCH) may be transmitted with a first TCI in a first time period 410 and transmitted with a second TCI in a second, subsequent, time period 412.

A single TCI can provide a common beam for multiple channels. Multiple types of unified TCI are available, including a joint TCI, a downlink TCI, and an uplink TCI. The first type of TCI (Type 1) is a joint TCI state to indicate a common beam for at least one downlink channel or reference signal (RS) and at least one uplink channel or reference signal. The channel may be a UE-specific physical downlink control channel (PDCCH), physical downlink shared channel (PDSCH), physical uplink control channel (PUCCH), or physical uplink shared channel (PUSCH). The second type of TCI (Type 2) is a separate downlink TCI state to indicate a common beam for more than one downlink channel or reference signal. The channel may be a UE-specific PDCCH or PDSCH. The third type of TCI (Type 3) is a separate uplink TCI state to indicate a common beam for more than one uplink channel or reference signal. The channel may be a UE-specific PUCCH or PUSCH.

Some aspects of the present disclosure apply when two sticky unified TCIs are originally indicated, but later, only one sticky TCI is indicated. These aspects pertain to a single downlink control information (sDCI) mTRP PDSCH, such as a configured semi-persistent scheduled (SPS) PDSCH. In this case, the DCI may be an activating DCI for a radio resource control (RRC) configured SPS.

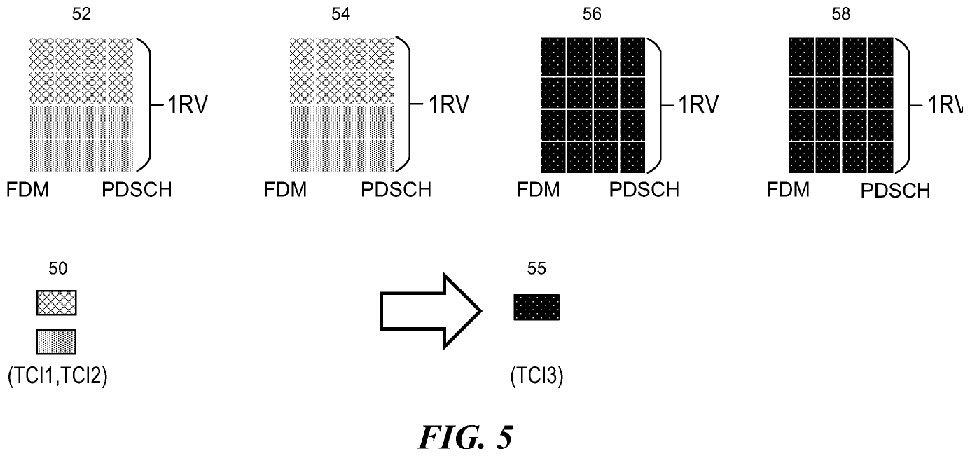

In some aspects, a sDCI configured mTRP frequency division multiplexed (FDM) PDSCH is transmitted. In these aspects, one TCI is assigned for each half of a frequency domain resource assignment (FDRA) where a single redundancy version is indicated. FIG. 5 is a block diagram illustrating frequency division multiplexed (FDM) semi persistently scheduled (SPS) physical downlink shared channel (PDSCH) transmissions, in accordance with aspects of the present disclosure. As shown in FIG. 5, at time 50, two TCI states (TCI 1, TCI 2) are signaled in the activation DCI. At time 52, a first TCI state (TCI 1) and a second TCI state (TCI 2) are applied to a PDSCH with a single redundancy version (1 RV), such that half of the frequency domain resource allocation (FDRA) uses one of the TCI states and the other half of the FDRA uses the other TCI state. Similarly, at time 54, the first TCI state (TCI 1) and the second TCI state (TCI 2) are applied to the PDSCH with the single redundancy version (1 RV), such that half of the frequency domain resource allocation (FDRA) uses one of the TCI states and the other half of the FDRA uses the other TCI state.

At time 55, the activation DCI indicates a third TCI state (TCI 3). According to aspects of the present disclosure, at times 56 and 58, all FDRA parts use the later indicated TCI (TCI 3) for the single RV PDSCH.

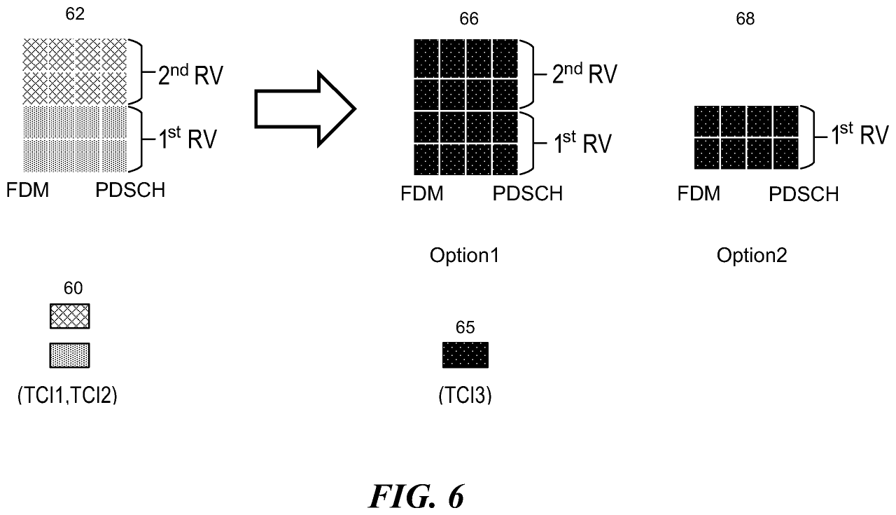

In case two redundancy versions (RVs) are present, one TCI may apply to each repetition (e.g., each RV). FIG. 6 is a block diagram illustrating frequency division multiplexed (FDM) semi persistently scheduled (SPS) physical downlink shared channel (PDSCH) transmission for two redundancy versions, in accordance with aspects of the present disclosure. At time 60, an activating DCI indicates two TCIs (TCI 1, TCI 2). Two repetitions of a PDSCH correspond to a first RV and a second RV. In the example of FIG. 6, at time 62, the first RV uses the first TCI (TCI 1), and the second RV uses the second TCI (TCI2). At time 65, an activating DCI indicates a third TCI (TCI 3).

According to some optional aspects of the present disclosure, all repetitions use the later TCI. For example, at time 66, both the first RV and second RV use the third TCI (TCI 3). In alternative aspects, only the first repetition is kept. The first repetition uses the later indicated TCI, or one of the originally mapped first or second TCIs. Referring again to FIG. 6, the second option is illustrated at time 68, where the first repetition is transmitted with the third TCI (TCI 3). Not shown is the case where one of the originally mapped TCIs is applied to the first repetition, while the second repetition is not transmitted. In the example of FIG. 6, the first repetition is mapped to the first TCI (TCI 1). Thus, the first repetition at time 68 would use the first TCI (TCI 1) in this not illustrated option.

Time division multiplexing (TDM) scenarios are now discussed. In case multiple repetitions are transmitted within a single slot (e.g., intra-slot), both repetitions may use a later signaled TCI. How to handle a configured gap between the two repetitions is now discussed.

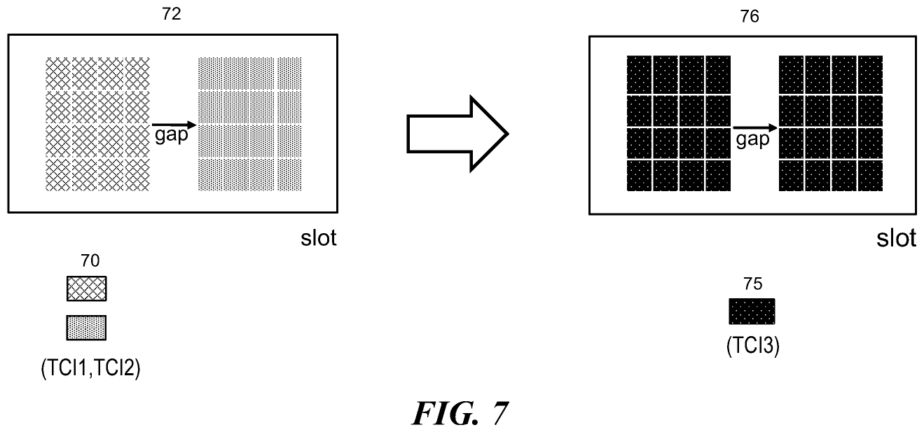

FIG. 7 is a block diagram illustrating intra-slot time division multiplexed repetitions, in accordance with aspects of the present disclosure. As shown in FIG. 7, at time 70, an activating DCI indicates two TCIs (TCI 1, TCI2). In the example of FIG. 7, at time 72, the first repetition uses the first TCI (TCI 1), and the second repetition uses the second TCI (TCI 2). A gap is configured between the first and second repetitions. At time 75, an activating DCI indicates a third TCI (TCI 3). At time 76, the repetitions both use the third TCI (TCI 3). In the illustrated first option, the gap is kept between the repetitions. The gap may be needed for TCI switching from the first TCI to the second TCI.

In alternative aspects (not shown), the gap is reset to zero, or is ignored between the repetitions, because there is no TCI switching between repetitions. In still other alternative aspects, only the first repetition is kept, with the later indicated TCI (e.g., TCI 3), or the originally mapped first or second TCI.

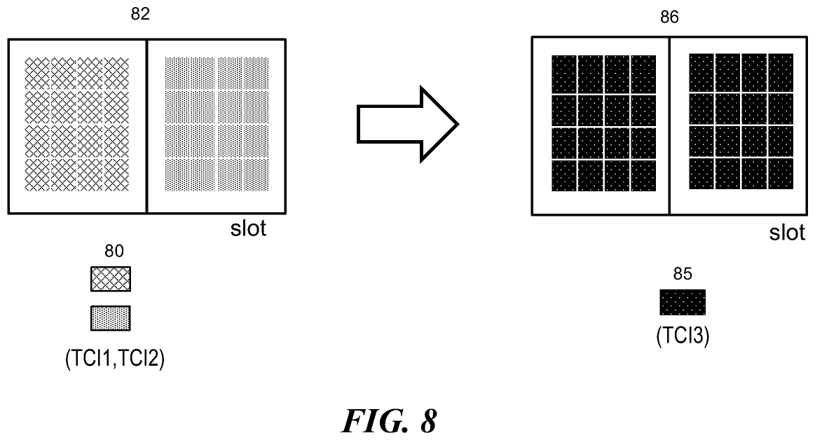

In case multiple repetitions are transmitted in different slots (e.g., inter-slot), both repetitions may use a later signaled TCI. FIG. 8 is a block diagram illustrating inter-slot time division multiplexed repetitions, in accordance with aspects of the present disclosure. As shown in FIG. 8, at time 80, an activating DCI indicates two TCIs (TCI 1, TCI 2). In the example of FIG. 8 at time 82, the first repetition uses the first TCI (TCI 1), and the second repetition uses the second TCI (TCI 2). At time 85, an activating DCI indicates a third TCI (TCI 3). At time 86, both repetitions use the third TCI (TCI 3). In aspects not illustrated, only the first repetition is kept. In this option, the first repetition uses the later indicated TCI (e.g., TCI 3), or the originally mapped first or second TCI. Although the preceding description refers to two repetitions, more than two repetitions are contemplated, with the techniques of the present disclosure applied to the three or more repetitions.

FIG. 9 is a flow diagram illustrating an example process 900 performed, for example, by a user equipment (UE), in accordance with various aspects of the present disclosure. The example process 900 is an example of a transmission configuration indicator (TCI) framework for multiple transmission and reception points (mTRPs). The operations of the process 900 may be implemented by a UE 120.

At block 902, the user equipment (UE) receives a first indication for a first unified transmission configuration indicator (TCI) and a second unified TCI during a first time period. Each of the TCIs corresponds to a portion of a transmission. For example, the UE (e.g. using the antenna 252, DEMOD/MOD 254, MIMO detector 256, receive processor 258, controller/processor 280, memory 282, and/or the like) may receive the first indication. The transmission may be an FDRA, TDM (intra-slot or inter-slot) repetitions, or FDM repetitions. At block 904, the user equipment (UE) receives a second indication for a third unified TCI during a second time period, which occurs after the first time period. For example, the UE (e.g. using the antenna 252, DEMOD/MOD 254, MIMO detector 256, receive processor 258, controller/processor 280, memory 282, and/or the like) may receive the second indication.

At block 906, the user equipment (UE) determines whether to apply to the transmission, the third unified TCI, the first unified TCI or the second unified TCI. For example, the UE (e.g. using the controller/processor 280, memory 282, and/or the like) may determine which unified TCI to apply to the transmission. If the transmission is an FDRA, the UE may determine to apply the third unified TCI to all of the FDRA. If the transmission includes multiple FDM repetitions, the UE may determine to apply the third unified TCI to all of the repetitions or may determine to apply one of the unified TCIs to a first repetition while refraining from transmitting any other repetition. If the transmission includes multiple TDM intra-slot repetitions, the UE may determine to apply the third unified TCI to all of the repetitions while either maintaining or eliminating a configured gap. In other aspects with multiple TDM intra-slot repetitions, the UE applies the first second or third unified TCI to only one repetition, while refraining from transmitting any another repetition. If the transmission includes multiple TDM inter-slot repetitions, the UE may determine to apply the third unified TCI to all of the repetitions or may determine to apply one of the unified TCIs to a first repetition while refraining from transmitting any other repetition.

FIG. 10 is a flow diagram illustrating an example process 1000 performed, for example, by a network device, in accordance with various aspects of the present disclosure. The example process 1000 is an example of a transmission configuration indicator (TCI) framework for multiple transmission and reception points (mTRPs).

At block 1002, the network device transmits a first indication for a first unified transmission configuration indicator (TCI) and a second unified TCI during a first time period. Each of the TCIs corresponds to a portion of a transmission. For example, the network device (e.g. using the antenna 234, MOD/DEMOD 232, TX MIMO processor 230, transmit processor 220, controller/processor 240, memory 242, and/or the like) may transmit the first indication. The transmission may be an FDRA, TDM (intra-slot or inter-slot) repetitions, or FDM repetitions. The network device may be a CU or DU, in some examples, or may be part of a core network. At block 1004, the network device transmits a second indication for a third unified TCI during a second time period, after the first time period. For example, the network device (e.g. using the antenna 234, MOD/DEMOD 232, TX MIMO processor 230, transmit processor 220, controller/processor 240, memory 242, and/or the like) may transmit the second indication.

At block 1006, the network device communicates in accordance with the third unified TCI, the first unified TCI or the second unified TCI. For example, the network device (e.g. using the antenna 234, MOD/DEMOD 232, TX MIMO processor 230, transmit processor 220, MIMO detector 236, receive processor 238, controller/processor 240, memory 242, and/or the like) may communicate in accordance with a selected unified TCI. If the transmission is an FDRA, the communication may be with the third unified TCI for all of the FDRA. If the transmission includes multiple FDM repetitions, the communication may be with third unified TCI for all of the repetitions or one of the unified TCIs for a first repetition while another repetition is not sent. If the transmission includes multiple TDM intra-slot repetitions, the communication may be with the third unified TCI for all of the repetitions while either maintaining or eliminating a configured gap. In other aspects with multiple TDM intra-slot repetitions, the communication may be with the first second or third unified TCI for only one repetition, while other repetitions are not transmitted. If the transmission includes multiple TDM inter-slot repetitions, the communication may be with the third unified TCI for all of the repetitions or one of the unified TCIs for a first repetition while another repetition is not transmitted.

### Example Aspects

Aspect 1: A method of wireless communication by a user equipment communicating with a multiple transmission and reception point (mTRP) system, comprising: receiving a first indication for a first unified transmission configuration indicator (TCI) and a second unified TCI during a first time period, each of the TCIs corresponding to a portion of a transmission; receiving a second indication for a third unified TCI during a second time period, after the first time period; and determining whether to apply to the transmission, the third unified TCI, the first unified TCI or the second unified TCI.

Aspect 2: The method of Aspect 1, further comprising receiving a configuration for a semi-persistently scheduled (SPS) physical downlink shared channel (PDSCH), in which the transmission comprises a frequency domain resource allocation (FDRA) and the determining determines to apply the third unified TCI to all of the FDRA.

Aspect 3: The method of Aspect 1 or 2, in which a single redundancy version is indicated for the PDSCH.

Aspect 4: The method of Aspect 1, in which the transmission comprises a plurality of frequency division multiplexed repetitions and the determining determines to apply the third unified TCI to the plurality of frequency division multiplexed repetitions.

Aspect 5: The method of Aspect 1, in which the transmission comprises a plurality of frequency division multiplexed repetitions and the determining determines to apply the third unified TCI, the first unified TCI or the second unified TCI, to one of the plurality of frequency division multiplexed repetitions while refraining from transmitting another frequency division multiplexed repetition.

Aspect 6: The method of Aspect 1, in which the transmission comprises a plurality of time division multiplexed intra-slot repetitions separated by a gap, and the determining determines to apply the third unified TCI to the plurality of time division multiplexed intra-slot repetitions while maintaining the gap.

Aspect 7: The method of Aspect 1, in which the transmission comprises a plurality of time division multiplexed intra-slot repetitions separated by a gap, and the determining determines to apply the third unified TCI to the plurality of time division multiplexed intra-slot repetitions while eliminating the gap.

Aspect 8: The method of Aspect 1, in which the transmission comprises a plurality of time division multiplexed intra-slot repetitions separated by a gap, and the determining determines to apply the third unified TCI, the first unified TCI or the second unified TCI, to one of the plurality of time division multiplexed intra-slot repetitions while refraining from transmitting another time division multiplexed intra-slot repetition.

Aspect 9: The method of Aspect 1, in which the transmission comprises a plurality of time division multiplexed inter-slot repetitions, and the determining determines to apply the third unified TCI to the plurality of time division multiplexed inter-slot repetitions.

Aspect 10: The method of Aspect 1, in which the transmission comprises a plurality of time division multiplexed inter-slot repetitions, and the determining determines to apply the third unified TCI, the first unified TCI or the second unified TCI, to one of the plurality of time division multiplexed inter-slot repetitions while refraining from transmitting another time division multiplexed inter-slot repetition.

Aspect 11: A method of wireless communication by a network device in a multiple transmission and reception point (mTRP) system, comprising: transmitting a first indication for a first unified transmission configuration indicator (TCI) and a second unified TCI during a first time period, each of the TCIs corresponding to a portion of a transmission; transmitting a second indication for a third unified TCI during a second time period, after the first time period; and communicating in accordance with the third unified TCI, the first unified TCI or the second unified TCI.

Aspect 12: The method of Aspect 11, further comprising transmitting a configuration for a semi-persistently scheduled (SPS) physical downlink shared channel (PDSCH), in which the transmission comprises a frequency domain resource allocation (FDRA) and the communicating is in accordance with the third unified TCI for all of the FDRA.

Aspect 13: the Method of Aspect 11 or 12, in Which a Single Redundancy version is indicated for the PDSCH.

Aspect 14: The method of Aspect 11, in which the transmission comprises a plurality of frequency division multiplexed repetitions and the communicating is in accordance with the third unified TCI for the plurality of frequency division multiplexed repetitions.

Aspect 15: The method of Aspect 11, in which the transmission comprises a plurality of frequency division multiplexed repetitions and the communicating is in accordance with the third unified TCI, the first unified TCI or the second unified TCI, for one of the plurality of frequency division multiplexed repetitions while another frequency division multiplexed repetition is not transmitted.

Aspect 16: The method of Aspect 11, in which the transmission comprises a plurality of time division multiplexed intra-slot repetitions separated by a gap, and the communicating is in accordance with the third unified TCI for the plurality of time division multiplexed intra-slot repetitions while maintaining the gap.

Aspect 17: The method of Aspect 11, in which the transmission comprises a plurality of time division multiplexed intra-slot repetitions separated by a gap, and the communicating is in accordance with the third unified TCI for the plurality of time division multiplexed intra-slot repetitions while eliminating the gap.

Aspect 18: The method of Aspect 11, in which the transmission comprises a plurality of time division multiplexed intra-slot repetitions separated by a gap, and the communicating is in accordance with the third unified TCI, the first unified TCI or the second unified TCI, for one of the plurality of time division multiplexed intra-slot repetitions while another time division multiplexed intra-slot repetition is not transmitted.

Aspect 19: The method of Aspect 11, in which the transmission comprises a plurality of time division multiplexed inter-slot repetitions, and the communicating is in accordance with the third unified TCI for the plurality of time division multiplexed inter-slot repetitions.

Aspect 20: The method of Aspect 11, in which the transmission comprises a plurality of time division multiplexed inter-slot repetitions, and the communicating is in accordance with the third unified TCI, the first unified TCI or the second unified TCI, for one of the plurality of time division multiplexed inter-slot repetitions while another time division multiplexed inter-slot repetition is not transmitted.

Aspect 21: An apparatus for wireless communication by a user equipment communicating with a multiple transmission and reception point (mTRP) system, comprising: a memory; and at least one processor coupled to the memory, the at least one processor configured: to receive a first indication for a first unified transmission configuration indicator (TCI) and a second unified TCI during a first time period, each of the TCIs corresponding to a portion of a transmission; to receive a second indication for a third unified TCI during a second time period, after the first time period; and to determine whether to apply to the transmission, the third unified TCI, the first unified TCI or the second unified TCI.

Aspect 22: The apparatus of Aspect 21, in which the at least one processor is further configured to receive a configuration for a semi-persistently scheduled (SPS) physical downlink shared channel (PDSCH), in which the transmission comprises a frequency domain resource allocation (FDRA) and the at least one processor is further configured to apply the third unified TCI to all of the FDRA.

Aspect 23: The apparatus of Aspect 21 or 22, in which a single redundancy version is indicated for the PDSCH.

Aspect 24: The apparatus of Aspect 21, in which the transmission comprises a plurality of frequency division multiplexed repetitions and the at least one processor is further configured to apply the third unified TCI to the plurality of frequency division multiplexed repetitions.

Aspect 25: The apparatus of Aspect 21, in which the transmission comprises a plurality of frequency division multiplexed repetitions and the at least one processor is further configured to apply the third unified TCI, the first unified TCI or the second unified TCI, to one of the plurality of frequency division multiplexed repetitions while refraining from transmitting another frequency division multiplexed repetition.

Aspect 26: The apparatus of Aspect 21, in which the transmission comprises a plurality of time division multiplexed intra-slot repetitions separated by a gap, and the at least one processor is further configured to apply the third unified TCI to the plurality of time division multiplexed intra-slot repetitions while maintaining the gap.

Aspect 27: The apparatus of Aspect 21, in which the transmission comprises a plurality of time division multiplexed intra-slot repetitions separated by a gap, and the at least one processor is further configured to apply the third unified TCI to the plurality of time division multiplexed intra-slot repetitions while eliminating the gap.

Aspect 28: The apparatus of Aspect 21, in which the transmission comprises a plurality of time division multiplexed intra-slot repetitions separated by a gap, and the at least one processor is further configured to apply the third unified TCI, the first unified TCI or the second unified TCI, to one of the plurality of time division multiplexed intra-slot repetitions while refraining from transmitting another time division multiplexed intra-slot repetition.

Aspect 29: The apparatus of Aspect 21, in which the transmission comprises a plurality of time division multiplexed inter-slot repetitions, and the at least one processor is further configured to apply the third unified TCI to the plurality of time division multiplexed inter-slot repetitions.

Aspect 30: The apparatus of Aspect 21, in which the transmission comprises a plurality of time division multiplexed inter-slot repetitions, and the at least one processor is further configured to apply the third unified TCI, the first unified TCI or the second unified TCI, to one of the plurality of time division multiplexed inter-slot repetitions while refraining from transmitting another time division multiplexed inter-slot repetition.

Aspect 31: An apparatus for wireless communication by a network device in a multiple transmission and reception point (mTRP) system, comprising: a memory; and at least one processor coupled to the memory, the at least one processor configured: to transmit a first indication for a first unified transmission configuration indicator (TCI) and a second unified TCI during a first time period, each of the TCIs corresponding to a portion of a transmission; to transmit a second indication for a third unified TCI during a second time period, after the first time period; and to communicate in accordance with the third unified TCI, the first unified TCI or the second unified TCI.

Aspect 32: The apparatus of Aspect 31, in which the at least one processor is further configured to transmit a configuration for a semi-persistently scheduled (SPS) physical downlink shared channel (PDSCH), in which the transmission comprises a frequency domain resource allocation (FDRA) and the at least one processor is further configured to communicate in accordance with the third unified TCI for all of the FDRA.

Aspect 33: The apparatus of Aspect 31 or 32, in which a single redundancy version is indicated for the PDSCH.

Aspect 34: The apparatus of Aspect 31, in which the transmission comprises a plurality of frequency division multiplexed repetitions and the at least one processor is further configured to communicate in accordance with the third unified TCI for the plurality of frequency division multiplexed repetitions.

Aspect 35: The apparatus of Aspect 31, in which the transmission comprises a plurality of frequency division multiplexed repetitions and the at least one processor is further configured to communicate in accordance with the third unified TCI, the first unified TCI or the second unified TCI, for one of the plurality of frequency division multiplexed repetitions while another frequency division multiplexed repetition is not transmitted.

Aspect 36: The apparatus of Aspect 31, in which the transmission comprises a plurality of time division multiplexed intra-slot repetitions separated by a gap, and the at least one processor is further configured to communicate in accordance with the third unified TCI for the plurality of time division multiplexed intra-slot repetitions while maintaining the gap.

Aspect 37: The apparatus of Aspect 31, in which the transmission comprises a plurality of time division multiplexed intra-slot repetitions separated by a gap, and the at least one processor is further configured to communicate in accordance with the third unified TCI for the plurality of time division multiplexed intra-slot repetitions while eliminating the gap.

Aspect 38: The apparatus of Aspect 31, in which the transmission comprises a plurality of time division multiplexed intra-slot repetitions separated by a gap, and the at least one processor is further configured to communicate in accordance with the third unified TCI, the first unified TCI or the second unified TCI, for one of the plurality of time division multiplexed intra-slot repetitions while another time division multiplexed intra-slot repetition is not transmitted.

Aspect 39: The apparatus of Aspect 31, in which the transmission comprises a plurality of time division multiplexed inter-slot repetitions, and the at least one processor is further configured to communicate in accordance with the third unified TCI for the plurality of time division multiplexed inter-slot repetitions.

Aspect 40: The apparatus of Aspect 31, in which the transmission comprises a plurality of time division multiplexed inter-slot repetitions, and the at least one processor is further configured to communicate in accordance with the third unified TCI, the first unified TCI or the second unified TCI, for one of the plurality of time division multiplexed inter-slot repetitions while another time division multiplexed inter-slot repetition is not transmitted.

Aspect 41: An apparatus for wireless communication by a user equipment (UE) including means to perform the method of claims 1-10.

Aspect 42: An apparatus for wireless communication by a network device including means to perform the method of claims 11-20.

Aspect 43: A non-transitory computer-readable medium having program code recorded thereon, the program code executed by at least one processor of a user equipment (UE) and comprising program code to perform the method of claims 1-10.

Aspect 44: A non-transitory computer-readable medium having program code recorded thereon, the program code executed by at least one processor of a network device and comprising program code to perform the method of claims 11-20.

The foregoing disclosure provides illustration and description, but is not intended to be exhaustive or to limit the aspects to the precise form disclosed. Modifications and variations may be made in light of the above disclosure or may be acquired from practice of the aspects.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled with the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

As used, the term “component” is intended to be broadly construed as hardware, software, and/or a combination of hardware and software. As used, a processor is implemented in hardware, software, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, software, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method of wireless communication by a user equipment communicating with a multiple transmission and reception point (mTRP) system, comprising:
receiving a first indication for a first unified transmission configuration indicator (TCI) and a second unified TCI during a first time period, each of the TCIs corresponding to a portion of a transmission;
receiving a second indication for a third unified TCI during a second time period, after the first time period; and
determining whether to apply to the transmission, the third unified TCI, the first unified TCI or the second unified TCI.

2. The method of claim 1, further comprising receiving a configuration for a semi-persistently scheduled (SPS) physical downlink shared channel (PDSCH), in which the transmission comprises a frequency domain resource allocation (FDRA) and the determining determines to apply the third unified TCI to all of the FDRA.

3. The method of claim 2, in which a single redundancy version is indicated for the PDSCH.

4. The method of claim 1, in which the transmission comprises a plurality of frequency division multiplexed repetitions and the determining determines to apply the third unified TCI to the plurality of frequency division multiplexed repetitions.

5. The method of claim 1, in which the transmission comprises a plurality of frequency division multiplexed repetitions and the determining determines to apply the third unified TCI, the first unified TCI or the second unified TCI, to one of the plurality of frequency division multiplexed repetitions while refraining from transmitting another frequency division multiplexed repetition.

6. The method of claim 1, in which the transmission comprises a plurality of time division multiplexed intra-slot repetitions separated by a gap, and the determining determines to apply the third unified TCI to the plurality of time division multiplexed intra-slot repetitions while maintaining the gap.

7. The method of claim 1, in which the transmission comprises a plurality of time division multiplexed intra-slot repetitions separated by a gap, and the determining determines to apply the third unified TCI to the plurality of time division multiplexed intra-slot repetitions while eliminating the gap.

8. The method of claim 1, in which the transmission comprises a plurality of time division multiplexed intra-slot repetitions separated by a gap, and the determining determines to apply the third unified TCI, the first unified TCI or the second unified TCI, to one of the plurality of time division multiplexed intra-slot repetitions while refraining from transmitting another time division multiplexed intra-slot repetition.

9. The method of claim 1, in which the transmission comprises a plurality of time division multiplexed inter-slot repetitions, and the determining determines to apply the third unified TCI to the plurality of time division multiplexed inter-slot repetitions.

10. The method of claim 1, in which the transmission comprises a plurality of time division multiplexed inter-slot repetitions, and the determining determines to apply the third unified TCI, the first unified TCI or the second unified TCI, to one of the plurality of time division multiplexed inter-slot repetitions while refraining from transmitting another time division multiplexed inter-slot repetition.

11. A method of wireless communication by a network device in a multiple transmission and reception point (mTRP) system, comprising:
transmitting a first indication for a first unified transmission configuration indicator (TCI) and a second unified TCI during a first time period, each of the TCIs corresponding to a portion of a transmission;
transmitting a second indication for a third unified TCI during a second time period, after the first time period; and
communicating in accordance with the third unified TCI, the first unified TCI or the second unified TCI.

12. The method of claim 11, further comprising transmitting a configuration for a semi-persistently scheduled (SPS) physical downlink shared channel (PDSCH), in which the transmission comprises a frequency domain resource allocation (FDRA) and the communicating is in accordance with the third unified TCI for all of the FDRA,
wherein a single redundancy version is indicated for the PDSCH.

13. (canceled)

14. The method of claim 11, in which the transmission comprises a plurality of frequency division multiplexed repetitions and the communicating is in accordance with the third unified TCI for the plurality of frequency division multiplexed repetitions.

15. The method of claim 11, in which the transmission comprises a plurality of frequency division multiplexed repetitions and the communicating is in accordance with the third unified TCI, the first unified TCI or the second unified TCI, for one of the plurality of frequency division multiplexed repetitions while another frequency division multiplexed repetition is not transmitted.

16. The method of claim 11, in which the transmission comprises a plurality of time division multiplexed intra-slot repetitions separated by a gap, and the communicating is in accordance with the third unified TCI for the plurality of time division multiplexed intra-slot repetitions while maintaining the gap.

17. The method of claim 11, in which the transmission comprises a plurality of time division multiplexed intra-slot repetitions separated by a gap, and the communicating is in accordance with the third unified TCI for the plurality of time division multiplexed intra-slot repetitions while eliminating the gap.

18. The method of claim 11, in which the transmission comprises a plurality of time division multiplexed intra-slot repetitions separated by a gap, and the communicating is in accordance with the third unified TCI, the first unified TCI or the second unified TCI, for one of the plurality of time division multiplexed intra-slot repetitions while another time division multiplexed intra-slot repetition is not transmitted.

19. The method of claim 11, in which the transmission comprises a plurality of time division multiplexed inter-slot repetitions, and the communicating is in accordance with the third unified TCI for the plurality of time division multiplexed inter-slot repetitions.

20. The method of claim 11, in which the transmission comprises a plurality of time division multiplexed inter-slot repetitions, and the communicating is in accordance with the third unified TCI, the first unified TCI or the second unified TCI, for one of the plurality of time division multiplexed inter-slot repetitions while another time division multiplexed inter-slot repetition is not transmitted.

21. An apparatus for wireless communication by a user equipment communicating with a multiple transmission and reception point (mTRP) system, comprising:
a memory; and
at least one processor coupled to the memory, the at least one processor configured:
to receive a first indication for a first unified transmission configuration indicator (TCI) and a second unified TCI during a first time period, each of the TCIs corresponding to a portion of a transmission;
to receive a second indication for a third unified TCI during a second time period, after the first time period; and
to determine whether to apply to the transmission, the third unified TCI, the first unified TCI or the second unified TCI.

22-44. (canceled)
